(19) United States
(12) Patent Application Publication
(10) Pub. No.: US 2026/0275121 A1
(43) Pub. Date: Sep. 17, 2026

(54) COMPOSITION OF ANTI-CORROSION COATING

(71) Applicant: CIA. INDUSTRIAL H. CARLOS SCHNEIDER, Joinville (BR)

(72) Inventors: Marcelo DA SILVA GOMES, Santo André (BR); Filipe POSSAMAI DE SOUZA, Joinville (BR); Luidgi PAOLO PEDRAZZA, Joinville (BR)

(21) Appl. No.: 19/469,175

(22) PCT Filed: May 29, 2024
(86) PCT No.: PCT/BR2024/050221

§ 371 Date: Sep. 25, 2025

(30) Foreign Application Priority Data
Jun. 2, 2023 (BR) 1020230108865

(51) Int. Cl. C09D 5/10; C09D 1/00; C09D 5/08; C09D 7/20; C09D 7/40; C09D 7/61; C09D 7/63; C09D 7/65; C09D 163/00; C09D 175/06; C25D 3/22

(52) U.S. Cl. CPC C09D 5/103; C09D 1/00; C09D 5/086; C09D 7/20; C09D 7/61; C09D 7/63; C09D 7/65; C09D 7/67; C09D 163/00; C09D 175/06; C25D 3/22

(57) ABSTRACT

The present invention belongs to the field of compositions for coating, more specifically, it deals with a composition of a multilayer anticorrosive coating (R) with at least three layers, the base layer (1) being electrolytic or organometallic, a nanoceramic sealant as an intermediate layer (2), and an outer layer (3) of epoxy resin or polyester-polyurethane. The base layer (1) consists of an organometallic dispersion based on zinc and aluminum alloys or a base of zinc or zinc alloys applied electrolytically to a metallic surface (not pictured). Thus, in addition to having an affordable cost, the (R) coating of this invention has efficiency against corrosion by acid attack much higher than the coatings of the state of the art, that is, it has resistance to at least 40 test cycles of Kesternich AHT 2.0 S.

The present invention belongs to the field of compositions for coating, more specifically, it deals with a composition of a multilayer anticorrosive coating endowed with at least three layers, the base layer being electrolytic or organometallic, a nanoceramic sealant as an intermediate layer, and an outer layer containing epoxy resin or polyester-polyurethane resin.

Advantageously, the proposed coating composition has superior chemical resistance to zinc-based coatings, which are widely known worldwide as an excellent protective. In addition, it enhances the resistance to chemical corrosion caused when in contact with acidic substances, or even when in the presence of moisture, which helps to dissolve the metal and transport the corrosion products away from the metal surface.

### BACKGROUND OF THE ART

Corrosion is a natural process of material deterioration that occurs due to the interaction between the material and the environment around it. It is a common phenomenon that affects a wide range of materials, from metals to concrete and plastics.

Corrosion occurs when there is a chemical reaction between the material and corrosive agents, such as oxygen, water, acids, or salts. These agents corrode the surface of the material, resulting in mass loss, structural weakening, and ultimately component failure. In addition, corrosion can cause aesthetic damage, compromising the appearance of the material.

There are several types of corrosion, each with its distinct characteristics. In particular, there is corrosion caused by chemical attack, which is a process of deterioration of materials caused by the interaction of chemical substances with the surface of the material. This form of corrosion can occur due to exposure to acids, bases, salts, or other corrosive chemicals.

Corrosive processes generate many problems regarding the financial costs of replacing equipment and accessories, as well as reducing their useful life. An example is the storage and/or transportation of acidic chemicals, in which the damage is even greater, due to the high reactivity and potential for corrosive attack.

Corrosion of metal parts by acid attack occurs when the metal reacts with acidic substances, causing the metal to lose its continuity and deteriorate over time. The corrosion rate is influenced by several factors, including the type of metal, the acid concentration, the temperature, and the presence of other corrosion inhibitors or accelerators, such as humidity.

Thus, it is important to emphasize that the selection of the appropriate material, protective coatings, control of acid conditions and the application of monitoring techniques are essential strategies to prevent corrosion of metal parts by acid attack.

In this context, in order to prevent corrosion, metal parts are commonly coated with protective coatings and/or treated with corrosion inhibitors, and zinc-based coatings are usually used. Zinc is widely used as a sacrificial coating, known as galvanizing, where it is applied in layer form over the metal surface. Zinc acts as an anode, sacrificing itself over the base metal in the event of exposure to corrosion. In this way, the zinc is preferentially corroded, protecting the underlying metal.

However, it is important to consider the environment and exposure conditions when choosing the most appropriate protective coating for a specific application, considering that although zinc is widespread worldwide as an excellent protective, when protection against acid attacks is verified, it is clear that it is not enough.

This is because acid attacks on zinc-based coatings occur when acidic substances react with zinc, causing zinc corrosion. Zinc is a reactive metal and corrodes relatively easily in acidic environments to form hydrogen gas, which usually causes bubbles and/or metal peeling. Consequently, this can result in cavities forming, which penetrate the zinc coating and expose the underlying metal to further corrosion.

In addition to the concentration and type of acid, the corrosion rate can also be influenced by factors such as the presence of other metals in the coating, the presence of moisture, and the temperature. To prevent acid attacks, zinc-based coatings can be treated with corrosion inhibitors and/or can be coated with additional layers of protection, such as paint or a clear protective coating.

One way to evaluate the corrosion resistance of metal surfaces is through the Kesternich test, also known as acid salt spray test. It is a standardized laboratory test performed by exposing the metal surface to a controlled environment containing sulfur dioxide gas and high humidity, which simulates corrosive atmospheric conditions. The duration of exposure is typically between 24 and 72 hours.

The Kesternich test works by simulating, in a standardized way, the conditions that can lead to corrosion in real-world environments, such as industrial or coastal environments where sulfur dioxide and high humidity levels are present. The test results can be used to evaluate the effectiveness of corrosion inhibitors or to compare the corrosion resistance of different metal surfaces or coatings.

After the exposure period, the metal surface is inspected for signs of corrosion, such as rust or corrosion. The severity of the corrosion is then assessed using standardized methods, such as weight loss or visual inspection, to quantify the level of corrosion resistance. The results of the Kesternich test can provide valuable information for the selection and design of metal components and coatings needed to function in corrosive environments.

Sulfur dioxide exposure corrosion testing (Kesternich) is standardized by several international and national standardization organizations, including:
ASTM G87: This American Society for Testing and Materials (ASTM) standard standard test method for evaluating the resistance of metals and metal alloys to sulfide stress corrosion cracking in corrosive environments. The Kesternich test is one of the methods specified in this standard.
DIN 50018: This German standard specifies the test methods for evaluating the resistance of metal surfaces to corrosion caused by sulphur dioxide. The Kesternich test is one of the methods specified in this standard.
ABNT NBR 8096-Coated and uncoated metallic material-Corrosion due to exposure to sulfur dioxide. This Standard prescribes the (Kesternich) method for performing sulphur dioxide exposure tests.

An example, shown in FIG. 1, corresponds to a 2-liter Kesternich test cycle, called 2.0, which involves exposing a sample of the material to a volume of 2 liters of SO2 for a period of 24 hours. Every 24 hours there is a cycle. The test is performed for n cycles until the specimen shows corrosion in the base metal. The number of cycles supported by the specimen indicates the degree of corrosion resistance of the material for the test.

It is known that conventional zinc-based coatings have low resistance to the Kesternich test, that is, when exposed to acid salt spray, which simulates more severe conditions, these coatings may have lower performance. Therefore, if the application requires high resistance to the Kesternich test, the use of more advanced and specific coatings for this purpose is recommended.

Viewing a technical and affordable solution, the objective of this invention is to provide a high efficiency coating against corrosion by acid attack, resistance to at least 40 test cycles of Kesternich AHT 2.0 S, aiming to offer the market an alternative solution to stainless steel and with efficiency much higher than conventional coatings such as zinc flakes, electrolytic zinc and zinc alloys.

In addition, it is an objective of this invention to provide a coating, endowed with three distinct layers applied to the same metal piece that allows it to be used for applications in more aggressive environments, such as the agricultural, livestock and civil construction markets.

### BRIEF DESCRIPTION OF THE DRAWINGS

FIG. 1 illustrates the result of a test of screws with organometallic coating (Zinc Flake) after 2 cycles of Kesternich AHT 2.0 S test.

FIG. 2 illustrates fasteners after 21 cycles of Kesternich AHT 2.0 S, using epoxy resin on the outer layer (3).

FIG. 3 illustrates fasteners after 21 cycles of Kesternich AHT 2.0 S, using polyester-polyurethane resin on the outer layer (3).

FIG. 4 illustrates fasteners after 30 cycles of Kesternich AHT 2.0 S, using epoxy resin on the outer layer (3).

FIG. 5 illustrates fasteners after 30 cycles of Kesternich AHT 2.0 S, using polyester-polyurethane resin on the outer layer (3).

FIG. 6 illustrates fasteners after 40 cycles of Kesternich AHT 2.0 S, using epoxy resin on the outer layer (3).

FIG. 7 illustrates fasteners after 40 cycles of Kesternich AHT 2.0 S, using polyester-polyurethane resin in the outer layer (3).

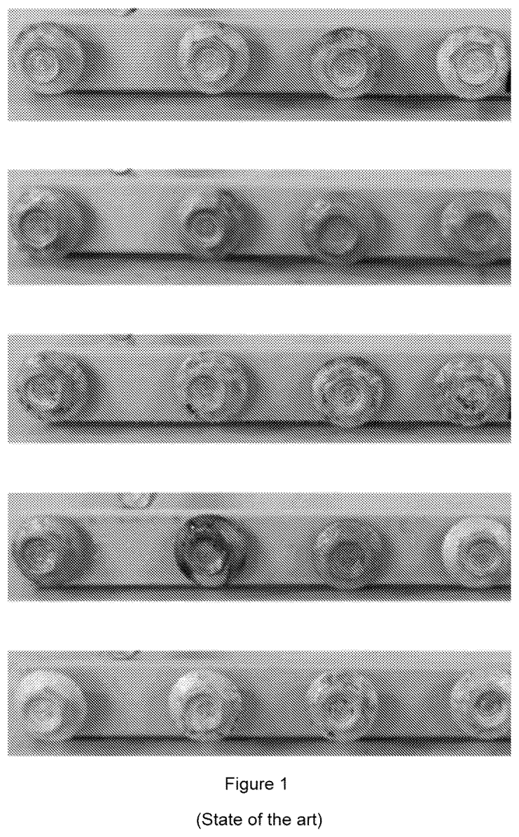

### DETAILED DESCRIPTION

The present invention discloses a multilayer coating (R) configured by at least three types of distinct layers applied to the same metallic part, with at least one base layer (1) being electrolytic or organometallic, at least one nanoceramic sealant as an intermediate layer (2), and at least one outer layer (3) of epoxy resin or polyester-polyurethane.

In addition to having an affordable cost, the coating (R) of this invention has much higher efficiency against corrosion by acid attack, that is, resistance to at least 40 test cycles of Kesternich AHT 2.0 S, with the objective of offering the market an alternative solution to stainless steel and with much higher efficiency than conventional coatings, such as zinc flakes, electrolytic zinc and zinc alloys.

Thus, the composition of the triple layer coating (R), makes the upper coating, or outer layer (3), which will be in direct contact with the aggressive environment, withstand for longer the aggressiveness related to acid attacks improving the performance of traditional coated carbon steel fasteners, where zinc is easily attacked and the useful life of the fastener or metal part is drastically decreased, and thus having a bad cost-benefit ratio.

At the same time, the triplex coating (R) of the present invention has a resistance to natural corrosion (weathering) far superior to traditional coatings, due to the combination of the intermediate layer (2) of a nanotechnology sealant with the outer layer (3).

It should be noted that the base layer (1) and the intermediate layer (2) are the subject of patent application BR102022011647-4, by the same holder, and the base layer (1) is a base of zinc or zinc alloys applied in an electrolytic manner or a base coating of an organometallic dispersion (zinc flake) based on zinc and aluminum alloys in a water base or organic solvents, containing binding elements, organic solvents, or water, alcohols, and ethers.

Thus, in one embodiment of the invention, the base layer (1) is made of electrolytic zinc.

For the purpose of defining the application of the base layer (1), the cathode is the electrode in which the metal reduction and deposition occurs—the object that will be covered, and the anode is the electrode in which oxidation occurs, which can be soluble—in this case the anode metal goes into the solution- or insoluble.

The electrolytes are so called all solutions that conduct the electric current. Ions are so called the charged particles that move around in the solution.

Galvanizing is the process of coating one metal by another in order to protect it against corrosion and improve its appearance. It is therefore a process of surface coating by means of electrolysis where the metal to be coated works as a cathode and the metal that will coat the part works as the anode (some inert material can also be used as an anode).

The electrolyte solution must contain a salt composed of cations of the metal that is to coat the part.

In general, different metals can be used for the coating of a part. The zinc coating process is called zinc plating. Zinc plating is a surface treatment that provides great resistance to corrosion, whereby the protective layer is uniform and adherent.

The zinc plating time determines the thickness of the deposited layer. In the present invention, the thickness of the electrolytic zinc or zinc alloys layer is between 5 and 18 micrometers, and the following zinc plating variants (rotary or stationary bath) can be used:
Alkaline zinc plating without cyanide, rotary and still bath;
Acid zinc plating;
Zinc/Iron Zinc Plating;
Zinc Nickel Zinc Plating.

In the present invention, electrolytic zinc or zinc alloys of 5 to 25 micrometers can be used, with acid zinc up to 12 micrometers and alkaline zinc as of 12 micrometers.

### Acid Zinc Plating

Zinc deposition processes from an acid solution were developed more than 200 years ago. The first processes were based on zinc sulfate. Even today, this type of process is used for applications where operation at high current densities is required, such as continuous lines of sheets or wires. In zinc processes that operate in rotary drums or dropouts, the suitable acidic processes are those that use chloride-based solutions.

The concentrations and operating conditions with three processes are described in Table-1.

TABLE 1
ZINC ACID BASE PROCESS

| | Ammonia | Potassium | Mixed |
|---|---|---|---|
| Zinc metal | 10 to 50 g/L | 20 to 50 g/L | 10 to 50 g/L |
| Ammonium | 110 to 180 g/L | 0 | 30 to 60 g/L |
| Chloride | | | |
| Potassium chloride | 0 | 180 to 360 g/L | 120 to 180 g/L |
| Boric acid | 0 | 22 to 40 g/L | 0 |
| pH | 5 to 6 | 4.5 to 5.5 | 5 to 6 |
| Temperature (° C.) | 10 to 40 | 18 to 45 | 10 to 50 |

The following are the considerations on the
operating parameters of zinc metal and chloride.

Zinc is replaced in the bath by means of the use of high-purity zinc anode in balls, bars, or ingots. As the process has good anodic corrosion efficiency, it is very easy to maintain the zinc concentration in the bath with good control of the anodic area.

Bar anodes are hung from the anode bus with titanium hooks, but it is much more common to use anode baskets constructed of titanium.

Chloride is responsible for the conductivity of the solution and anodic corrosion. High concentrations of chloride lower the turbidity point of the solution. Higher chloride concentration, higher tendency to burn at high current density, higher anode dissolution.

During electrolysis there is an evolution of hydrogen, according to the reaction shown above. With this, the pH rises and must be corrected with hydrochloric acid.

Ammonium chloride, in addition to the other functions, also serves as a pH buffer. When ammonia is not used, it is necessary to use boric acid for this function. For the complete elimination of ammonium chloride, it was necessary to develop new additive systems to achieve the same results reached with ammonia.

The additives were composed of non-water-soluble organic products that required solvents to remain soluble in the bath. These components were poorly tolerant to temperature, with turbidity points of the solution below 50° C., starting decomposition at temperatures of 30° C., causing stains and mists in the deposit, in addition to increasing organic contamination in the bath.

### Alkaline Zinc Plating

Cyanide-free alkaline electrolytic zinc is an environmentally friendly process (completely cyanide-free) that significantly reduces the amount of contaminated effluent generated. This process is indicated for iron, steel or zamak materials.

The use of this process provides the following advantages: excellent penetration; layer uniformity; freedom from white corrosion in weld areas, clear and bright deposits; It can be applied in a still bath process (larger items) or automatic rotary (smaller items).

After the application of zinc, the process is completed with passivation, which must be chosen according to the application characteristics of the items. For high-strength items, there is also an indication for the application of sealants.

TABLE 2
ZINC ALKALINE BASE PROCESS

| | Preferred Range | | Range | |
|---|---|---|---|---|
| Zinc Metal | 10 to 12 | g/L | 8 to 17 | g/L |
| Zinc Oxide | 12.5 to 15 | g/L | 10 to 21 | g/L |

(purity >99.8%)

| | | | | |
|---|---|---|---|---|
| Caustic Soda | 130 to 140 | g/L | 110 to 140 | g/L |
| Sodium Carbonate | 50 | g/L | <80 | g/L |
| Temperature | 26 to 30° | C. | 22 to 40° | C. |

| | |
|---|---|
| Cathodic Current Density | 0.5 to 6 A/dm² |
| Cathodic Efficiency | 50 to 75% |
| Deposited Layer | 0.2 micrometer/minute |
| | using 1 A/dm² |
| Agitation | Cathodic 3 to 5 m/minute |

(recommended)

In one embodiment of the invention, the base layer (1) is
organometallic (zinc flakes). Non-electrolytic organometallic coatings are made of lamellar zinc, providing good protection against corrosion. These coatings comprise a mixture of zinc and aluminum, which are bonded together by an inorganic matrix.

The specifications for organometallic coatings are defined in the international standards ISO 10683 and also in the European standard DIN EN 13858.

DIN EN ISO 10683 defines the requirements for organometallic coatings for threaded elements and DIN EN 13858 describes the requirements for zinc flake coatings for non-threaded elements and for other parts as well.

There are three groups of organometallic coatings:
Containing Cr(VI) (hexavalent chromium): surface treatments containing Cr(VI) provide greater protection against corrosion with a thinner layer, but Cr(VI) is carcinogenic and poses a potential risk to the environment. New European decrees prohibit the use of surface treatments containing Cr(VI). These include end-of-life vehicles and electrical and electronic equipment. For applications outside the automotive and electrical industries, these coatings are still valid.
Cr(VI) free-hexavalent chromium-free solvent-based coatings;
Cr(VI) free-hexavalent chromium-free water-based coatings;
Cr(VI) free coatings are more environmentally friendly than surface treatments that contain Cr(VI). No organometallic coating used in the automobile industry today contains this substance.

In one embodiment of the invention, the composition of the base layer is an organic solvent-based organometallic coating (zinc flakes) that comprises the following composition in percentage by weight:
from 20 to 60% zinc;
from 1 to 5% aluminum—from 10 to 20% of 2-Ethylhexanol;
from 5 to 10% naphtha (mineral oil), heavy hydrodesulfurized;
from 0 to 3% alcohol n-butyl 71-36-3 1;
1 to 3% Naptha solvent, petroleum, light aromatic;
1 to 3% stearic acid;
from 0 to 0.2% of Ethylbenzene;
from 0 to 0.2% standard solvent.

In another embodiment of the invention, the composition of the aqueous-based organometallic coating (zinc flakes) is configured by mixing compounds A, B and C which comprise the following composition in percentage by weight:

### Compound A

from 20 to 40% zinc;
from 2 to 10% aluminum
20 to 30% dipropylene glycol; from 1 to 2.5% nonionic surfactant;
15 to 20% deionized water

### Compound B

Silane (A-187)
70 to 90% deionized water
0.1 to 0.2% boric acid
2 to 3% sodium silicate

### Compound C

Hydroxyethylcellulose: 0.5 to 2 g per kg of mixture of compounds A+B.

Various manufacturers, such as car companies and their suppliers, have produced their own specifications and supply rules in order to define the requirements for these coating systems.

Organometallic coating (zinc flakes) is a generic term for coating technology.

Organometallic coatings are supplied in liquid form and can be applied using the following application techniques:
Before coating, the surface of the parts has to be pre-treated. In this process, pickling with acids, such as sulfuric acid or hydrochloric acid, is not used, which can produce atomic hydrogen and penetrate the steel structure and make it brittle. In order to avoid pickling processes, other pre-treatment processes are required. Typical cleaning processes are degreasing with an aqueous alkaline solution and then abrasive cleaning using blasting with steel microspheres.
Degreasing removes grease, oil and dirt from the surface of the metal;
Blasting removes surface oxidation through the mechanical action of steel microspheres, which are fired at parts inside a chamber using a turbine. None of the pretreatment processes produce any hydrogen, so there is no danger of any hydrogen embrittlement of high-strength steels.

After pre-treatment, the coating process is then carried out:
Spray: Coating is applied to the surface of the parts using a spray gun. This can be done manually or in a fully automated spraying facility (this process is used for larger or heavy parts). The pieces are packed in supports or hung on hangers or templates.
Dip-spin (immersion and centrifugation): The pieces are placed in a basket of a centrifuge. Coating is applied by immersion in a container filled with the coating and after immersion, the basket starts centrifugation in order to remove the excess coating material (this process is used for small high-volume parts, also called batch process).
Immersion-draining: By dipping the parts inside the coating material and pulling it out so that the set drains the excess coating, for example, into pipes. The parts must, however, have sufficient openings so that the material can run, otherwise the coating may have flaws such as coating build-ups and air bubbles.

The coating forms a liquid, uniform layer on the surface of the pieces. In order to develop the excellent properties of zinc flake coatings, a curing process is required.

The coated parts are cured in an oven at a controlled temperature for a set period. Typical curing temperatures are 200 to 340° C., as they depend on the technology applied, solvent-based or water-based. After curing, a uniform, thin, and adherent protective film is produced.

The average thickness of the base layer (1) is between 5 μm and 12 microns, and thicker layers can be applied.

The intermediate layer (2) is a nanoceramic sealant, more specifically an aqueous coating containing silicon oxide nanoparticles of up to 50 nanometers dispersed in water, binding elements, alcohols and ethers.

In summary, the sealant is applied as an intermediate layer (2), with the function of significantly increasing corrosion resistance.

The intermediate layer (2) is a liquid, free of heavy metals, applied in a similar way to organometallic coatings, by immersion and centrifugation, spray or immersion and draining, curing in an oven between 170° C. and 200° C. for a minimum of 25 minutes and a maximum of 240 minutes.

The nanoceramic sealant, i.e. the intermediate layer (2) comprises the following components by weight:
15% to 30% Colloidal Silica;
from 2.4% to 8% of 2-Butoxyethanol;
from 0% to 10% of Methanol;
from 50% to 70% of Water;
from 0% to 6% of Tetraethoxysilane;
from 0% to 2% polyvinyl alcohol.

Preferably, the intermediate layer (2) comprises the following components in the following proportions by weight:
15% to 32% Colloidal Silica;
from 2.4% to 8% of 2-Butoxyethanol;
10% Methanol;
50% Water.

In this way, the intermediate layer (2) promotes the sealing of the surface of the base layer (1), preventing or hindering the contact of the base layer (1) with the atmosphere and, in this way, increasing the life of the covered metal part.

Regarding the outer layer (3), in a preferential way of carrying out the invention, the base is epoxy resin and aluminum, that is, a coating rich in epoxy resin dispersed in water or organic solvents, aluminum and binding elements, being a viscous liquid, silver in color and contains the following compounds as a base in percentage by weight:
from 53 to 63% epoxy resin;
from 11 to 13% titanium oxide;
7 to 9% metallic aluminum; and
6 to 8% silicates.

In another way of carrying out the invention, the outer layer (3) is equipped with solvent-based polyester-polyurethane resin, being a viscous liquid, silver in color, which contains the following compounds as a percentage base:
20 to <30% propylene glycol methyl ether acetate (PMA);
from 10 to <20% of 1-methoxy-2-propanol;
from 1 to <3% Isopropanol;
1 to <3% n-butyl acetate;
<1% of 1-ethyl-2-pyrrolidinone;
<1% methyl isobutyl ketone (MIBK);
<1% Naphthalene;
<1% Toluene;
60 to <70% of other compounds below reported levels.

In addition, the outer layer (3) may contain some compound for lubricity, promoting adjustment of the coefficient of friction in the coated fasteners, which is not limited to 6 to 8% of polytetrafluoroethylene (PTFE).

The application of the outer layer (3) is carried out by immersion and centrifugation, spray or immersion and draining, and 1 to 3 layers can be applied, and each layer must be cured in an oven between 170° C. and 220° C., for 10 to 20 minutes.

The examples that will be presented illustrate the scope of the invention proposed here, and for all the examples described below, it was using the Kesternich test AHT 2.0 S according to the DIN 50018 standard:

### Example 1

The coating (R) configured by at least one base layer (1), one intermediate layer (2) and one outer layer (3), applied to the same metal part, in which the outer layer (3) comprises epoxy resin and aluminum, that is, a coating rich in epoxy resin dispersed in water or organic solvents, aluminum and binding elements was applied to fasteners to evaluate the resistance to acid attack, the fastener's head being the area considered for evaluation.

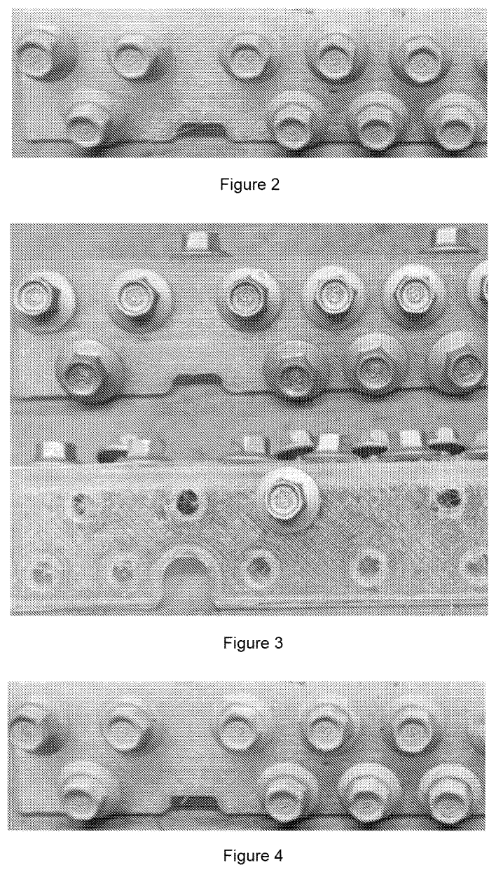

In FIG. 2 it is possible to observe the fasteners after 21 Kesternich cycles. It is noted that there was no corrosion formation.

### Example 2

The coating (R) configured by at least one base layer (1), an intermediate layer (2) and an outer layer (3), applied to the same metallic part, in which the outer layer (3) comprises solvent-based polyester-polyurethane resin, was applied to fasteners to evaluate the resistance to acid attack, and the area considered for evaluation was the head of the fastener.

In FIG. 3 it is possible to observe the fasteners after 21 Kesternich cycles. It is noted that there was no corrosion formation.

### Example 3

The coating (R) configured by at least one base layer (1), one intermediate layer (2) and one outer layer (3), applied to the same metal part, in which the outer layer (3) comprises epoxy resin and aluminum, that is, a coating rich in epoxy resin dispersed in water or organic solvents, aluminum and binding elements was applied to fasteners to evaluate the resistance to acid attack, the fastener's head being the area considered for evaluation.

In FIG. 4 it is possible to observe the fasteners after 30 Kesternich cycles. It is noted that there was no corrosion formation.

### Example 4

The coating (R) configured by at least one base layer (1), an intermediate layer (2) and an outer layer (3), applied to the same metallic part, in which the outer layer (3) comprises solvent-based polyester-polyurethane resin, was applied to fasteners to evaluate the resistance to acid attack, the fastener's head being the area considered for evaluation.

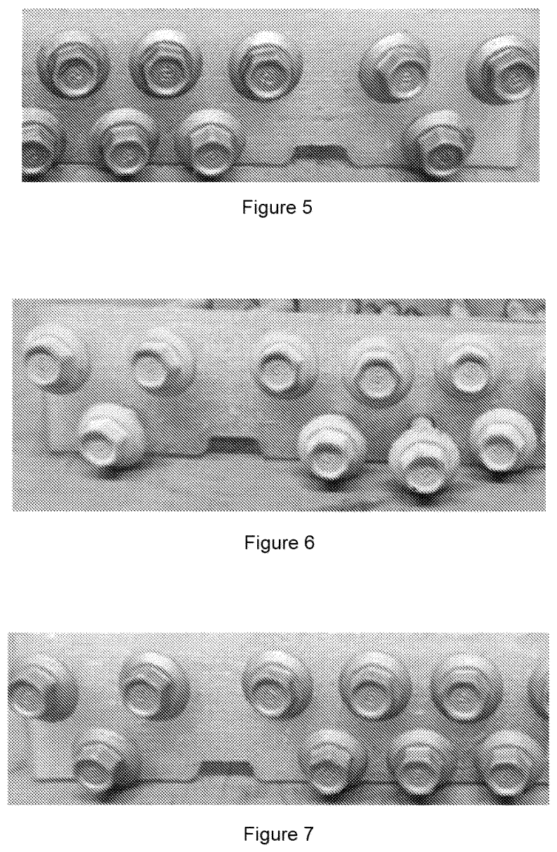

In FIG. 5 it is possible to observe the fasteners after 30 Kesternich cycles. It is noted that there was no corrosion formation.

### Example 5

The coating (R) configured by at least one base layer (1), one intermediate layer (2) and one outer layer (3), applied to the same metal part, in which the outer layer (3) comprises epoxy resin and aluminum, that is, a coating rich in epoxy resin dispersed in water or organic solvents, aluminum and binding elements was applied to fasteners to evaluate the resistance to acid attack, the fastener's head being the area considered for evaluation.

In FIG. 6 it is possible to observe the fasteners after 40 Kesternich cycles. It is noted that there was no corrosion formation, achieving the objective proposed by the invention.

### Example 6

The coating (R) configured by at least one base layer (1), an intermediate layer (2) and an outer layer (3), applied to the same metallic part, in which the outer layer (3) comprises solvent-based polyester-polyurethane resin, was applied to fasteners to evaluate the resistance to acid attack, the fastener's head being the area considered for evaluation.

In FIG. 7 it is possible to observe the fasteners after 40 Kesternich cycles. It is noted that there was no formation of corrosion, achieving the objective proposed by the invention.

1- A composition of a coating, where the referred coating (R) is configured by at least one base layer (1), an intermediate layer (2) and an outer layer (3), applied to the same metallic piece, in which the base layer (1) comprises:
an organometallic dispersion based on zinc and aluminium alloys, or
a base of zinc or zinc alloys applied electrolytically to the metal surface
the aqueous intermediate layer (2) comprising silicon oxide nanoparticles up to 50 nanometers and further comprising the following compounds as a percentage by weight:
15% to 32% of Colloidal Silica;
from 2.4% to 8% of 2-Butoxyethanol;
from 0% to 10% of Methanol;
from 50% to 70% of Water;
from 0% to 6% of Tetraethoxysilane;
from 0% to 2% polyvinyl alcohol;
characterized by the outer layer (3) comprising the following compounds as a percentage by weight:
from 53 to 63% epoxy resin;
from 11 to 13% titanium oxide;
7 to 9% metallic aluminum;
6 to 8% silicates;
or an outer layer (3) comprising solvent-based polyester-polyurethane resin with the following compounds as a percentage by weight:
20 to <30% propylene glycol methyl ether acetate (PMA);
from 10 to <20% of 1-methoxy 2-propanol;
from 1 to <3% Isopropanol;
1 to <3% n-butyl acetate;
<1% of 1-ethyl-2-pyrrolidinone;
<1% methyl isobutyl ketone (MIBK);
<1% Naphthalene;
<1% Toluene; and
60 to <70% of other compounds below reported levels.

2- The composition of a coating, according to claim 1, characterized by the outer layer (3) preferably comprising the following compounds as a percentage by weight:
58% epoxy resin;
12% titanium oxide;
8% metallic aluminum; and
7% silicates, preferably mica-type mineral.

3- The composition of a coating, according to claim 1, characterized by the outer layer (3) comprising 6 to 8% polytetra-fluorine-ethylene (PTFE).

4- The composition of a coating, according to claim 1, characterized by the base layer (1) being an organic solvent-based organometallic coating comprising the following composition in percentage by weight:
20 to 60% zinc;
2 to 10% aluminum
10 to 20% 2-Ethylhexanol;
5 to 10% naphtha (mineral oil), heavy hydrodesulfurized;
0 to 3% alcohol n-butyl 71-36-3 1;
1 to 3% Naptha solvent, petroleum, light aromatic;
1 to 3% stearic acid;
0 to 0.2% of Ethylbenzene;
0 to 0.2% standard solvent.

5- The composition of a coating, according to claim 1, characterized by the base layer (1) being water-based organometallic configured by mixing a compound A, a compound B and a compound C, where the compounds comprise the following composition as a percentage by weight:
COMPOUND A
from 20 to 40% zinc;
from 2 to 10% aluminum
20 to 30% Dipropylene Glycol
1 to 2.5% nonionic surfactant
15 to 20% deionized water
COMPOUND B
Silane (A-187)
70 to 90% deionized water
0.1 to 0.2% boric acid
2 to 3% sodium silicate
COMPOUND C
hydroxyethylcellulose of 0.5 to 2 g per kg of mixture of compounds A+B.
